(19) United States
(12) Patent Application Publication
(10) Pub. No.: US 2010/0153281 A1
(43) Pub. Date: Jun. 17, 2010

(54) SYSTEM AND METHOD FOR INITIATING WARRANTY COVERAGE AND PROVIDING WARRANTY STATUS FOR A MANUFACTURED ITEM

(75) Inventors: Cheng Tan, Cupertino, CA (US); Susan Tay, Varsity Park (SG)

Correspondence Address: Convergent Law Group LLP, P.O. BOX 1329, MOUNTAIN VIEW, CA, 94042, US

(73) Assignee: Provalidate, Cupertino, CA (US)

(21) Appl. No.: 12/337,166

(22) Filed: Dec. 17, 2008

(51) Int. Cl. G06Q 99/00

(52) U.S. Cl. 705/302

(57) ABSTRACT

In a system and method for initiating warranty coverage and providing warranty status for a manufactured item, an electronic device with a destructible extrusion is associated and supplied with the manufactured item, where detachment, unplugging, cutting, or tearing of the destructible extrusion is detected and initiates warranty coverage. The electronic device with the destructible extrusion is then attached in such a way as to require detachment, unplugging, cutting, or tearing of the destructible extrusion during an event that is appropriate to initiate warranty coverage. This may be the opening of the manufactured item's package, or it may be required before the manufactured item can be put to use.

### BACKGROUND OF THE INVENTION

Manufactured items may come with warranty coverage after purchase. Typically, this is for a fixed period of time from the date of purchase or the date of first use. Commonly, a warranty card needs to be filled out with purchase information and mailed in to initiate warranty coverage. Another option may be for the purchaser of the manufactured item to visit a website to enter purchase information.

These methods, however, suffer from purchaser or retailer inaction, manipulation and abuse. For instance, the warranty card may be forward dated to extend the warranty coverage period. The warranty card may also be left unfilled and only completed in such a way as to obtain warranty coverage when problems arise. Manufacturers may be hard pressed to prove any wrongdoing in these cases, and they may then be burdened with having to repair the manufactured items under warranty even though the items may be out of warranty had the proper procedures been followed.

It is desirable to provide an automated and tamper resistant means for initiating warranty coverage and providing warranty status for a manufactured item that coincides with an action such as the unpacking or use of the item.

### BRIEF SUMMARY OF THE INVENTION

The exemplary embodiment provides a system and method for initiating warranty coverage and providing warranty status for a manufactured item, comprising an electronic device with a destructible extrusion. The destructible extrusion is attachable to the manufactured item, and comprises a conductive loop of electrically conductive material held by an electrically non-conductive material, where the conductive loop has two endpoints through which an electric current can flow.

The electronic device comprises a continuity monitor attached to the endpoints of the conductive loop to monitor the electrical continuity of the conductive loop. A break in electrical continuity in the conductive loop is detected, and one of a timer and a processor is signaled to initiate warranty coverage. A readable interface allows access to warranty status.

### BRIEF DESCRIPTION OF SEVERAL VIEWS OF THE DRAWINGS

FIGS. 1A-B show block diagrams of the electronic components in exemplary embodiments.

FIG. 2 provides an operational overview for the system in an exemplary embodiment.

FIG. 3A shows an event diagram of an exemplary embodiment where the timer is a periodic timer (instead of a real-time clock).

FIG. 3B shows an event diagram of an exemplary embodiment where the timer is a real-time clock.

FIG. 4A shows an exemplary embodiment of the electronic device, a destructible extrusion, and a human-readable interface.

FIG. 4B shows an exemplary embodiment of the electronic device, a destructible extrusion in a different form, and a machine-readable interface.

FIGS. 5A-B show how the conductive loop can be made from separate sections to increase tamper resistance.

FIG. 6 shows how the electrical circuit for the conductive loop can be completed by electrically conductive material on the manufactured item.

### DETAILED DESCRIPTION OF THE INVENTION

The present invention relates to a system and method for automatically initiating warranty coverage and providing warranty status for a manufactured item. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention is mainly described in terms of particular components and materials provided in particular implementations. However, one of ordinary skill in the art will readily recognize that this system will operate effectively in other implementations. For example, the components and materials usable with the present invention can take a number of different forms, and the system operates effectively for other systems having different and/or additional components and materials not inconsistent with the present invention.

The exemplary embodiment provides a system and method for automatically initiating warranty coverage and providing warranty status for a manufactured item. An electronic device with a destructible extrusion is associated and attached to the manufactured item, where detachment, unplugging, cutting, or tearing of the destructible extrusion is detected and initiates warranty coverage. The electronic device with the destructible extrusion is then attached in such a way as to require detachment, unplugging, cutting, or tearing of the destructible extrusion during an event that is appropriate to initiate warranty coverage. This may be the opening of the manufactured item's package, or it may be required before the manufactured item can be put to use.

The components are low-cost, easy to manage, and tamper-resistant. Initiating warranty coverage is automatic and it can be tied to some activity that a purchaser or retailer would already normally do prior to completing a sale or using the manufactured item.

The manufacturer gains assurance that initiation of warranty coverage is done consistently and reliably, and warranty abuse is eliminated.

Components

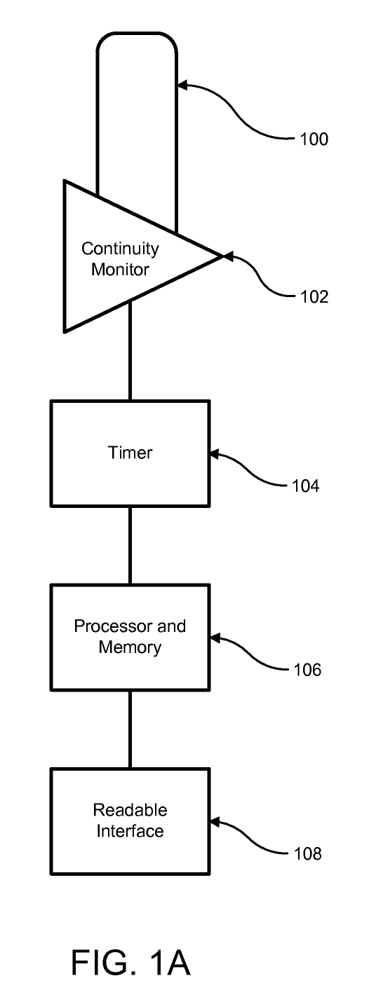

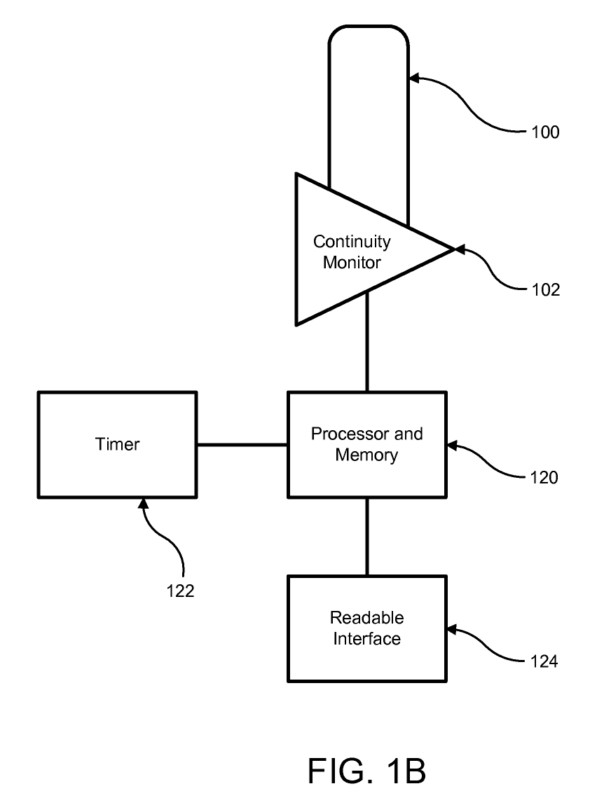

FIG. 1A is a component diagram of an embodiment of a system for initiating warranty coverage and providing warranty status for a manufactured item using an electronic device with a destructible extrusion. The system includes an electrically conductive loop 100, a continuity monitor 102, a timer 104, a processor and memory 106, and a readable interface 108.

In one embodiment, endpoints of the electrically conductive loop 100 are attached to a continuity monitor 102. The continuity monitor 102 monitors the electrically conductive loop 100 for loss of electrical continuity. Such loss may occur if the conductive loop is cut or broken.

The continuity monitor 102 may operate in the analog or digital domain. In the analog domain, continuity monitor 102 could use methods including a continuous or a periodic measure of resistance, current or voltage. In the digital domain, an subcomponent (not shown) of continuity monitor 102 could send a signal, which may comprise one or more pulses, periodically through the conductive loop 100 to a receiver subcomponent (not shown) of continuity monitor 102 that triggers loss of continuity if the receiver subcomponent misses one or more signals.

When the continuity monitor 102 detects a loss of electrical continuity in the electrically conductive loop 100, a signal is generated. The signal may comprise one or more pulses. In this embodiment, no other signals will be sent even if electrical continuity is restored to the electrically conductive loop 100 and continuity is broken again. In a different embodiment, multiple signals may be sent by the continuity monitor 102, but the receiver of the signals might act on only one of the signals, which may be the first.

The signal from continuity monitor 102 is used to initiate warranty coverage. The signal is sent to timer 104 in this embodiment, and timer 104 is activated in response to the signal. Timer 104 begins to send periodic signals to the processor and memory 106.

A counter variable (not shown) in the processor and memory 106 is initialized with a start value of 0, and the processor and memory 106 responds to each periodic signal from timer 104 by incrementing the counter variable. In this embodiment, the elapsed time between a present time and the start of the warranty coverage period can be computed by the following formula:

Elapsed Time=counter variable's value/timer signal frequency (where “/” is “divided by”)

For example, a counter variable value of 24 with a timer signal frequency of twice per hour means the elapsed time is 12 hours.

The warranty coverage period ends, in this embodiment, when the counter variable's value equals an end of warranty counter value. This end of warranty counter value may be programmed into the processor instructions during manufacture, or it could be stored in non-volatile memory that is accessible to the processor 106.

The processor and memory 106 can further process the counter variable's value to provide a variety of warranty status information. These derived values include:

1. A day-by-day countdown counter until the end of the warranty coverage period where the value reaches and remains at 0, or transitions to some final value. For example, a countdown counter for a two-year warranty coverage period can have the number starting at 730 and counting down by one each day until it reaches and remains at 0.

2. A count-up counter until the end of the warranty coverage period where it can continue, stop at a maximum value, or transition to some final value.

3. A progress or drain value. This can be a percentage of warranty coverage used or warranty coverage left.

4. A binary status indicator that indicates whether or not warranty coverage is still in effect.

5. A code within which the counter variable's value or one of its derivatives is embedded or encrypted. This may be an option if it is undesirable for an unauthorized user to see the actual value.

A readable interface 108 is provided to allow access to the counter variable's value or one of the derived values as stated above. It can then be determined if the manufactured item is still under warranty coverage. Examples of the readable interface 108 include a human-readable display such as an LCD, and an LED display, and a machine-readable interface such as the electrical contacts on smart cards as specified in ISO 7816-2.

FIG. 1B is a component diagram of a another embodiment of a system for initiating warranty coverage and providing warranty status for a manufactured item using an electronic device with a destructible extrusion.

In this embodiment, electrically conductive loop 100 and continuity monitor 102 are used in a manner similar to the embodiment in FIG. 1A described above. As with the embodiment in FIG. 1A, the signal from continuity monitor 102 that is generated when the electrical continuity of electrically conductive loop 100 is broken initiates warranty coverage, but the signal is sent, in this embodiment, to the processor and memory 120. Also in this embodiment, timer 122 is a real-time clock that is synchronized with a standard time, such as GMT, during manufacture. The processor and memory 120, upon receiving the signal from continuity monitor 102 will read and record the time from timer 122 in a timestamp variable (not shown).

In this embodiment, the elapsed time between a present time and the start of the warranty coverage can be computed by the following formula:

Elapsed Time=current time from timer 122−timestamp variable's value

The processor and memory 120 can further process the timestamp variable's value to derive a variety of warranty status information. These derived values include:

1. A day-by-day countdown counter until the end of the warranty coverage period where the value reaches and remains at 0, or transitions to some final value.

2. A count-up counter until the end of the warranty coverage period where it can continue, stop at a maximum value, or transition to some final value.

3. A progress or drain value. This can be a percentage of warranty coverage used or warranty coverage left.

4. A binary status indicator that indicates whether or not warranty coverage is still in effect.

5. A code within which the timestamp variable's value or one of its derivatives is embedded or encrypted. This may be an option if it is undesirable for an unauthorized user to see the actual value.

6. The starting date and/or time for the warranty coverage.

7. The ending date and/or time for the warranty coverage, according to this formula:

the end time for the warranty coverage=the timestamp variable's value+the duration of the warranty coverage period.

The warranty coverage period ends, in this embodiment, when a present time is greater than or equal to the end time for warranty coverage (calculated with the formula in #7 above). The duration of the warranty coverage period may be programmed into the processor instructions during manufacture, or it could be stored in a non-volatile memory that is accessible to the processor 120.

A readable interface 124 is provided to allow access to the timestamp variable's value or one of the derived values as stated above. It can then be determined if the manufactured item is still under warranty coverage.

Operational Overview

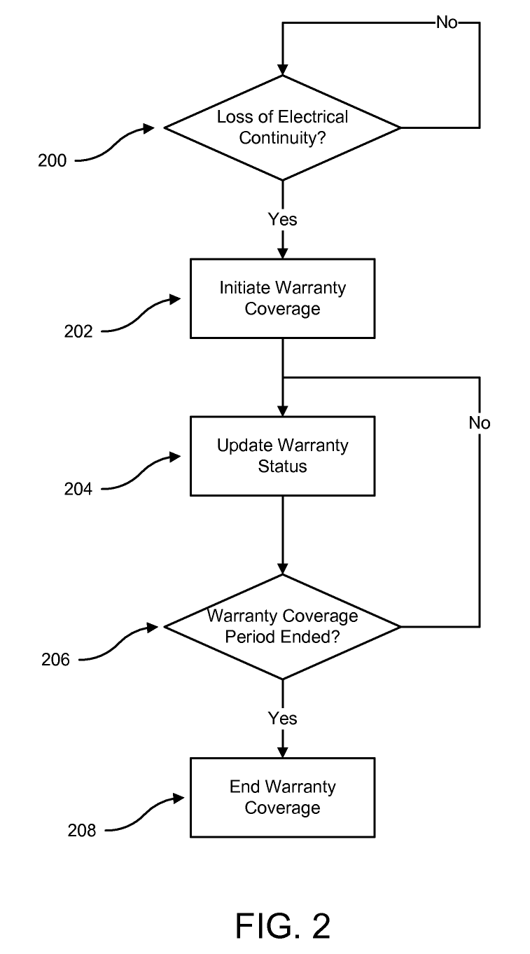

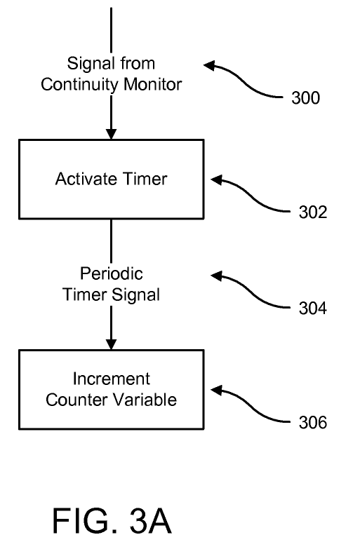

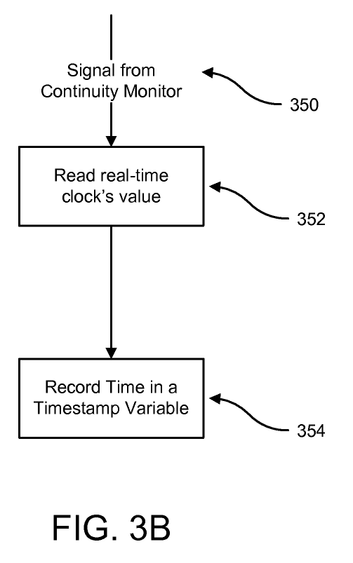

FIG. 2 provides an operational overview of an exemplary embodiment of the system in the form of a flow diagram. An electrically conductive loop (not shown) is monitored for loss of electrical continuity, block 200. When loss of electrical continuity is detected, the warranty coverage is initiated, block 202. This may involve signaling a timer 104 as discussed with FIG. 1A above and with FIG. 3A below, or signaling a processor 120 as discussed with FIG. 1B above and with FIG. 3B below.

The system, in this embodiment, then enters a warranty status update loop where the warranty status is updated, block 204, and a check is made to see if the warranty coverage period has ended, block 206. These steps may involve updating a counter or deriving warranty status information as discussed with FIGS. 1A and 1B above.

If the warranty coverage period is complete, the warranty coverage is ended, block 208. This may involve updating the warranty status to a final or ended state. The internal components such as the timer (104 or 122 in FIGS. 1A and 1B) and processor and memory (106 or 120 in FIGS. 1A and 1B) may be shut down or put to sleep at this time.

The warranty status that is updated in blocks 204 and 208 is accessible through a readable interface (not shown).

Event Diagrams

FIG. 3A is an event diagram for how the system responds to a loss of electrical continuity in the electrically conductive loop 100 for the embodiment as described in FIG. 1A where the timer is either not synchronized to a standard time or is inactive until it is activated.

In FIG. 3A, the signal from the continuity monitor 102 is sent to the timer 104 in step 300. In response, the timer is activated in step 302. When activated, the timer begins to send timer signals periodically to the processor and memory 106, in step 304. In response, the processor 106 increments the counter variable, in step 306.

FIG. 3B is an event diagram for how the system responds to a loss of electrical continuity in the electrically conductive loop 100 for the embodiment as described in FIG. 1B where the timer is a real time clock that is synchronized to a standard time, such as GMT, during manufacture.

The signal from the continuity monitor 102 is sent to the processor and memory 120 in step 350. The processor and memory 120 reads the value of timer 122 in step 352, and records the value in a timestamp variable in step 354.

### PHYSICAL EMBODIMENTS

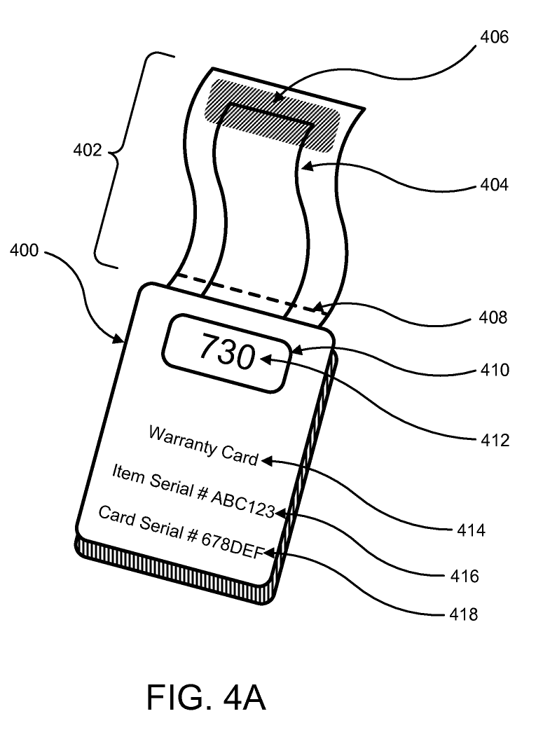

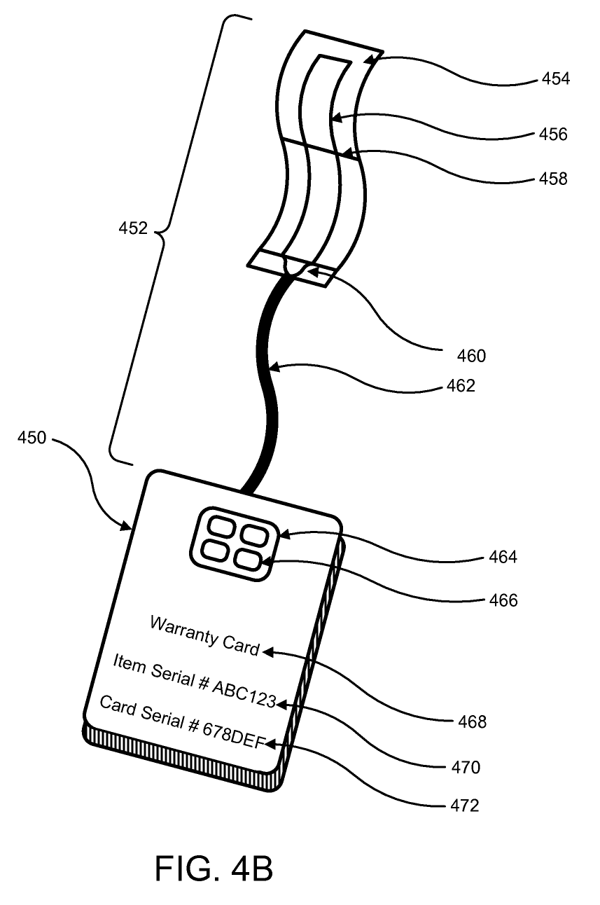

FIG. 4A is a drawing of an exemplary embodiment of a device for initiating warranty coverage and providing warranty status for a manufactured item using an electronic device with a destructible extrusion. The electronic device 400 is in the form of a card. The card 400 houses the continuity monitor 102, the timer (104 or 122 in FIGS. 1A and 1B), the processor and memory (106 or 120 in FIGS. 1A and 1B), and the readable interface components (108 or 124 in FIGS. 1A and 1B). Electronic device 400 has a destructible extrusion 402 attached that is made of flexible, electrically non-conductive material such as plastic. Embedded within destructible extrusion 402, in this embodiment, is the electrically conductive loop 404, the ends of which are connected to the continuity monitor within the electronic device 400. The conductive loop 404 may be any electrically conductive material deposited, laid down, or embedded on or within the non-conductive material. An adhesive backing 406 allows the destructible extrusion 402 to be wrapped around a manufactured item and pasted back on itself, thereby requiring its removal before the manufactured item can be used. Perforation 408 is provided to help a person tear off the destructible extrusion 402. A notched cutout or a scoring of the material that makes up destructible extrusion 402 may also be used to ease removal.

A human-readable display 410 is provided in this embodiment, where a count 412 is displayed. The value that is shown in this example happens to be the value at the start of a two-year countdown, where the number represents the number of days left in the warranty coverage period. In other embodiments, different warranty status information may be shown, such as the counter and timestamp values, and the derived values mentioned with FIGS. 1A and 1B above.

Marking 414 identifies electronic device 400 as a warranty card in this embodiment.

Markings 416 and 418 are serial numbers that may be used to prevent misuse or abuse. Marking 416 is the serial number for the manufactured item. If the manufactured item has a unique serial number, marking 416 will tie the electronic device 400 to a specific manufactured item.

Card serial number 418 is the serial number for the electronic device 400. The manufacturer may choose to use this instead of, or in addition to the manufactured item's serial number 416. If card serial number 418 is used alone (i.e. without serial number 416), the assignment of a specific electronic device 400 to a specific manufactured item can be noted in a database by storing the serial numbers for both items in a database row to note the pairing. This would be useful for when a manufactured item is delivered for warranty repair with an electronic device 400 that is claimed to be the warranty card for the manufactured item. A database lookup can then be done with either the card serial number 418 or the manufactured item's serial number to discover the other serial number in the pairing for verification.

FIG. 4B is a drawing of another exemplary embodiment of a device for initiating warranty coverage and providing warranty status for a manufactured item using an electronic device with a destructible extrusion. The electronic device 450 is also in the form of a card. Electronic device 450 houses the continuity monitor 102, the timer (104 or 122 in FIGS. 1A and 1B), the processor and memory (106 or 120 in FIGS. 1A and 1B), and the readable interface components (108 or 124 in FIGS. 1A and 1B). Electronic device 450 has a destructible extrusion 452 that includes a flexible strip 454 and a flexible umbilical cord 462.

Flexible strip 454 may be made of an electrically non-conductive material such as plastic or paper. The conductive loop 456 may be any electrically conductive material deposited, laid down, or embedded on or within the non-conductive material. The flexible strip 454 is adhesive-backed, and this embodiment may be suitable for manufactured items such as watches where flexible strip 454 may be pasted onto a watch's case or back.

The flexible strip 454 is scored along 458 to ease breakage of the conductive loop when the flexible strip 454 is removed. The conductors of the conductive loop 456 are channeled at 460 to run through the flexible umbilical cord 462 within which the conductors are insulated from each other. If this embodiment were to be used with watches, for example, the flexible umbilical cord 462 would allow a prospective buyer to try the watch on prior to purchase without breaking the conductive loop.

The umbilical cord 462 does not need to be captively attached to the electronic device 450 as shown. A different embodiment may choose to attach the umbilical cord 462 to the electronic device 450 with an electrical connector such as a two-pin mini-plug, with the pins on the umbilical cord being connected to the ends of the conductive loop 456. In such an embodiment, unplugging the electrical connector will break the electrical continuity of the conductive loop.

A machine-readable display 464 is shown in this embodiment. Electrical contact pads 466 allow a machine reader to make electrical contact and communicate with the internal electronics to retrieve information which may include any combination of the counter and timestamp values, and the derived values mentioned with FIGS. 1A and 1B above.

Marking 468 identifies the electronic device 450 as a warranty card in this embodiment.

Markings 470 and 472 serve purposes similar to markings 416 and 418 in FIG. 4A. Marking 470 is the serial number for the manufactured item. If the manufactured item has a unique serial number, marking 470 will tie the electronic device 450 to a specific manufactured item.

Card serial number 472 is the serial number for the electronic device 450. The manufacturer may choose to use this instead of, or in addition to the manufactured item's serial number 470. If card serial number 472 is used alone (i.e. without serial number 470), the assignment of a specific electronic device 450 to a specific manufactured item can be noted in a database by storing the serial numbers for both items in a database row to note the pairing.

Conductive Loop Options

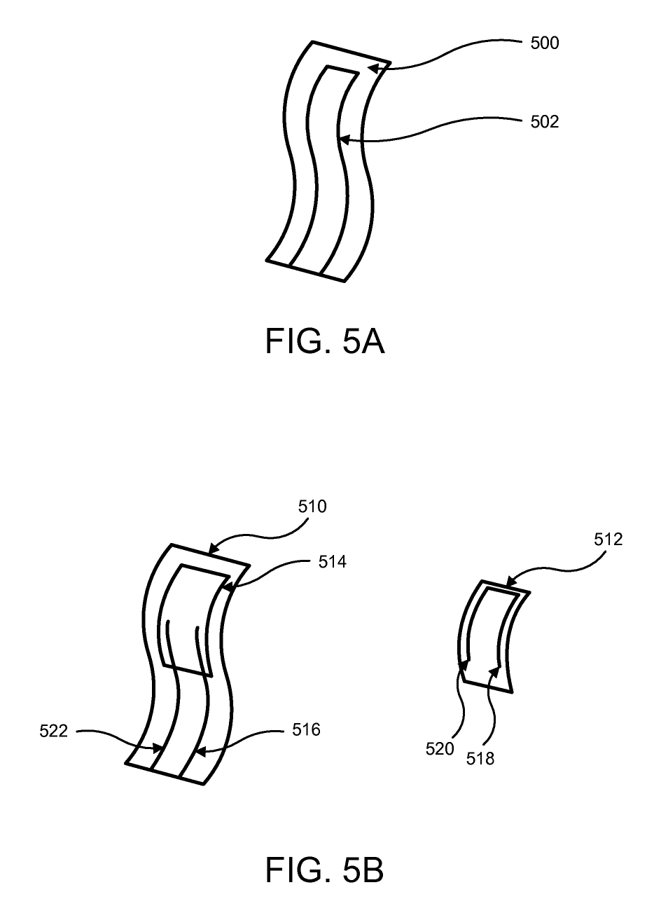

FIGS. 5A-B show how the conductive loop can be made from separate sections to increase tamper resistance.

FIG. 5A shows a strip of non-conductive material 500 within which a conductive loop 502 is placed.

FIG. 5B shows how the same form factor can be made from two layers of non-conductive material and separate sections of conductive loop material to increase tamper resistance.

Top views of two strips, 510 and 512, of flexible non-conductive material are shown.

Strip 510 has an area 514 underneath that is sized to fit the second strip 512. The bottom area of strip 510 outside of area 514 has adhesive, as does the underside of strip 512.

Strip 510 has two sections of conductive loop material, 516 and 522, which line up and partially overlap the conductive loop material 518 and 520 on strip 512 respectively. These overlapping sections of conductive loop material are exposed such that when strip 512 is mounted underneath strip 510 in area 514, the conductive loop materials on both strips 510 and 512 make electrical contact, thereby forming a single conductive loop, i.e., electricity can flow from conductive loop material 516 through conductive loop material 518, which then flows through conductive loop material 520 and on through conductive loop material 522. If desired, additional material such as conductive gel can be placed between the overlapping sections of conductive loop material to make or enhance the electrical connection between the sections.

The two overlapping strips are then used as the destructible extrusion in an embodiment and pasted on a manufactured item. When strip 510 is lifted or removed, the electrical continuity of the conductive loop is easily broken. Because strip 510 covers strip 512, the electrical contact between conductive loop material on the two strips is difficult to maintain when strip 510 is lifted or removed, thus achieving tamper resistance.

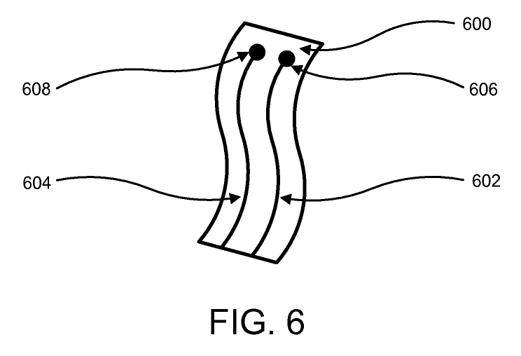

FIG. 6 shows how the electrical circuit for the conductive loop can be completed by electrically conductive material on the manufactured item.

A top view of a strip 600 of flexible non-conductive material is shown.

Strip 600 has two sections of conductive loop material, 602 and 604, which are terminated with electrical contact pads 606 and 608, respectively. The electrical contact pads 606 and 608 are exposed on the underside of strip 600. The underside of strip 600 outside of the electrical contact pads 606 and 608 may then be coated with adhesive to allow attachment of strip 600 to a manufactured item. A conductive loop can then be formed if it can be arranged such that electrical contact pads 606 and 608 make electrical contact with a contiguous section of electrically conductive material on the manufactured item, i.e. electricity can flow from conductive loop material 602 through electrical contact pad 606, then through the electrically conductive material on the manufactured item, then through electrical contact pad 608, and down through conductive loop material 604. If desired, additional material such as conductive gel can be placed on electrical contact pads 606 and 608 to make or enhance the electrical connection between the contact pads and the electrically conductive material on the manufactured item.

Electrical continuity would be broken once strip 600 is peeled off, and it is achieved in a tamper resistant manner.

It should not be taken as a limitation that only electrically conductive material on the manufactured item itself can be used to complete the electrical circuit for the conductive loop. Electrically conductive material on a container for the manufactured item, on a part or accessory, or on a container for a part or accessory can be used as well.

Attachment of the Destructible Extrusion

The attachment of the destructible extrusion is not limited to the manufactured item itself. If appropriate or desired, attachment can be made to an item such as a container for the manufactured item, to a part or accessory, or to a container for a part or accessory. The attachment can then be made in such a way as to require removal of the destructible extrusion prior to some action that is appropriate for initiating the warranty coverage period such as the opening of a container, or assembly with a part or accessory.

Warranty Repairs with the Electronic Device

If an embodiment of the electronic device with destructible extrusion is used as a warranty card, an entity such as a retailer, distributor, manufacturer, or repair facility can require that the electronic device accompany any manufactured item that is brought in or delivered for repair under warranty coverage. If appropriate, a check can first be made to see that the electronic device is indeed the device that was assigned to the manufactured item by doing a database lookup with the serial number of the card or the manufactured item (as mentioned with FIGS. 4A and 4B) and comparing the actual serial numbers to see that they match the pairing in the database. A check can also be made with the device to see that the warranty coverage is still in effect before accepting the manufactured item for repair.

A system and method for initiating warranty coverage and providing warranty status for a manufactured item using an electronic device with a destructible extrusion has been disclosed. The electronic device with the destructible extrusion is associated and attached to the manufactured item, where detachment, unplugging, cutting, or tearing of the destructible extrusion is detected and initiates warranty coverage. The electronic device with the destructible extrusion is then attached in such a way as to require detachment, unplugging, cutting, or tearing of the destructible extrusion during an event that is appropriate to initiate warranty coverage. This may be the opening of the manufactured item's package, or it may be required before the manufactured item can be put to use.

The components are low-cost, easy to manage, and tamper-resistant. Initiation of warranty coverage is automatic and it can be tied to some activity that a purchaser or retailer would already normally do prior to completing a sale or using the manufactured item.

The manufacturer gains assurance that initiation of warranty coverage is done consistently and reliably, and warranty abuse is eliminated.

The present invention has been described in accordance with the embodiments shown, and one of ordinary skill in the art will readily recognize that there could be variations to the embodiments, and any variations would be within the spirit and scope of the present invention. For example, the names associated with the various components, materials, states and their transitions may be changed and still fall within the scope of the present invention. Accordingly, many modifications may be made by one of ordinary skill in the art without departing from the spirit and scope of the appended claims.

What is claimed is:

1. A system for initiating warranty coverage and providing warranty status for a manufactured item, comprising:
an electronic device with a destructible extrusion, the destructible extrusion being attachable to the manufactured item,
wherein the destructible extrusion comprises:
a conductive loop of electrically conductive material held by an electrically non-conductive material, the conductive loop having two endpoints through which an electric current can flow;
wherein the electronic device comprises:
a continuity monitor attached to the endpoints of the conductive loop to monitor electrical continuity of the conductive loop, wherein a signal is generated by the continuity monitor when a break in the electrical continuity in the conductive loop is detected;
a timer;
a processor coupled to the timer, wherein one of the timer and the processor uses the signal generated by the continuity monitor to initiate the warranty coverage; and
a readable interface for access to the warranty status.

2. The system of claim 1 wherein the conductive loop operates in one of: an analog domain, and a digital domain.

3. The system of claim 1 wherein the conductive loop is allowed to break when one of these actions is performed on the destructible extrusion: detaching, unplugging, cutting, and tearing.

4. The system of claim 1 wherein the readable interface is one of: a human readable interface, and a machine readable interface.

5. The system of claim 1 wherein the readable interface allows retrieval of the warranty status.

6. The system of claim 1 wherein the readable interface shows the warranty status.

7. The system of claim 1 wherein the warranty status is one of: a countdown to an end of a warranty coverage period, a count up to the end of the warranty coverage period, a progress value, a drain value, an indicator as to whether the item is still under the warranty coverage, a first code wherein the warranty status is embedded, a second code wherein the warranty status is encrypted, at least one of a date and a time the warranty coverage period started, and at least one of a date and a time the warranty coverage period will end.

8. The system of claim 1 wherein the conductive loop comprises a plurality of separate sections of electrically conductive material.

9. The system of claim 1 wherein an electrical circuit for the conductive loop is completed by electrically conductive material on the manufactured item.

10. A method for initiating warranty coverage and providing warranty status for a manufactured item, comprising:
monitoring by a continuity monitor a conductive loop of electrically conductive material for electrical continuity;
receiving a signal by one of a timer and a processor when the conductive loop loses electrical continuity;
initiating a warranty coverage period in response to receiving the signal;
updating the warranty status and determining if the warranty coverage period has ended for a duration of the warranty coverage period;
determining that the warranty coverage is complete when the warranty coverage period has ended; and
providing access to the warranty status.

11. The method of claim 10 wherein updating the warranty status comprises updating any combination of: a counter, and deriving warranty status information.

12. The method of claim 10 wherein determining if the warranty coverage period has ended comprises comparing a counter variable's value with an end of warranty counter value, and determining that the warranty coverage period has ended when the counter variable's value equals the end of warranty counter value.

13. The method of claim 10 wherein determining if the warranty coverage period has ended comprises comparing a present time with an end time for the warranty coverage, and determining that the warranty coverage period has ended when the present time is greater than or equal to the end time for the warranty coverage.

14. The method of claim 10 wherein ending the warranty coverage when the warranty coverage period has ended comprises changing the warranty status to one of:
a final, and an ended status.

15. The method of claim 10 wherein providing access to the warranty status is by one of: a human readable interface, and a machine readable interface.

16. The method of claim 10 wherein the warranty status is one of: a countdown to an end of the warranty coverage period, a count up to the end of the warranty coverage period, a progress value, a drain value, an indicator as to whether the item is still under the warranty coverage, a first code wherein the warranty status is embedded, a second code wherein the warranty status is encrypted, at least one of a date and a time the warranty coverage period started, and at least one of a date and a time the warranty coverage period will end.
